(19) United States
(12) Patent Application Publication
(10) Pub. No.: US 2023/0334536 A1
(43) Pub. Date: Oct. 19, 2023

(54) COMPUTER IMPLEMENTED APPLICATION FOR REAL TIME, AUTHENTIC REVIEWS OF VENUES AND ADDITIONAL MODES

(71) Applicant: Samuel Brooks, Odenton, MD (US)

(72) Inventor: Samuel Brooks, Odenton, MD (US)

(21) Appl. No.: 17/869,463

(22) Filed: Jul. 20, 2022

Related U.S. Application Data
(60) Provisional application No. 63/224,050, filed on Jul. 21, 2021.

(51) Int. Cl. G06Q 30/0282; G06Q 30/0601; G06T 11/00

(52) U.S. Cl. CPC G06Q 30/0282; G06Q 30/0631; G06T 11/00; H04W 4/029

(57) ABSTRACT

A computer implemented application is provided having multiple modules and engines. In a first module and engine, the application uses location estimation technology, including geofencing, RFID tags, QR tags, and Bluetooth beacons to estimate a location of a user prior to allowing a user to leave a real time review or rating of a particular venue on the application. The user's location has to be verified to be in a particular geographical location or within an acceptable distance of the particular geographical location for a review or rating to be allowed to be published. In this manner, fraudulent negative and/or positive reviews are prevented. Further, the computer implemented application uses an avatar and an area map to display recent and current reviews and ratings in a user's geographical location that update in real time and provide recommendations based on a machine learning trained model.

### CROSS-REFERENCE TO RELATED APPLICATIONS

This application is a non-provisional application which claims priority to U.S. Provisional Patent Application No. 63/224,050 filed on Jul. 21, 2021, which is incorporated by reference in its entirety.

### FIELD OF THE DISCLOSURE

This disclosure generally relates to a computer implemented system and method for an application that relates to obtaining realistic and accurate reviews of multiple venues with interactive graphic icons that provide real time reviews of the venues. Further, the computer implemented system and method relate to a process for a personal avatar that mirrors the same actual location as a user whereby the application indicates to the user any entertainment options within a certain amount of distance from the user and the personal avatar can interact with various graphic icons in the application to view real time reviews of the venues available within a specific distance of the user. The computer implemented system and method may further relate to a process for being transported from one place to another via a car ride service in which virtual displays of a vehicle of choice is displayed to the user on the user computing device and music options are provided to the user.

### BACKGROUND

Currently, there are many web-based applications dedicated to requesting and receiving reviews about venues or services or products. Some of these well-known applications that may exclusively or partially serve as review sites include YELP, GOOGLE, FACEBOOK, INSTAGRAM, and a variety of other social media applications as well. These websites and/or applications usually allow any reviewer to post any comment with a ranking or indication of satisfaction of the services or establishment being reviewed. People may then come and look at these reviews and may be influenced whether or not to attend or otherwise engage with the venue, service, or products that were reviewed. What is often times the case is that these reviewers may leave false and fraudulent reviews. In many instances, the owners and friends of venues may leave false positive reviews in order to falsely lure and drive people to their venues. Further, reviewers may be paid to leave positive or negative reviews to damage the reputation of a venue, services, or products. Accordingly, knowing that this is happening, it becomes very hard for the average consumer to trust the accuracy and authenticity of many reviews that are currently available online.

Further, it is difficult to know which venues and sources of entertainment are going to have a great crowd and be as lively as one expects based on the reviews. It would be better if there were a system that in real time could communicate the true atmosphere and environment at any given time at a club, restaurant, outdoor event, or any other type of venue so that the user of the application could have an accurate picture and representation of the atmosphere of the venue.

Further, it would be desirable for the application to communicate with a car transportation enterprise to transport people to and from certain locations based on their interactions with reviews and venues that they intend to visit that day or night.

The presently disclosed application and methods, according to one or more non-limiting embodiments, addresses these and other existing needs.

### SUMMARY

In a non-limiting embodiment, a computer implemented application is provided for providing accurate real time reviews or ratings of venues. The computer implemented application may also be used as a locator of entertaining venues, including night life related venues such as bars, clubs, and restaurants, and a source for recommendations of potential venues based on a user's profile and preferences. In a non-limiting embodiment, a first step of the computer implemented method includes obtaining, via one or more processors of a location-aware smart computing device, a geographical location of a user at a particular venue prior to allowing a user to submit a review or a rating of the particular venue. A subsequent step of the computer implemented method may include comparing, via the one or more processors, the geographical location of the user with an established geographical location of the particular venue. The next step of the computer implemented method may include determining, via the one or more processors, whether the geographical location of the user is within an acceptable geographical range from the established geographical location of the particular venue. If the geographical location of the user is determined, via the one or more processors, to be within the acceptable geographical range from the established geographical location for the particular location, the computer implemented method may include prompting the user to provide the real time review and/or the real time rating on the computer implemented application. Notably, fraudulent reviews or ratings of the particular venue are prevented by first verifying the geographical location of the user and ensuring a user is at a venue before allowing the user to post publicly to the computer application a review or rating that may influence the rankings of the venue and other customer's perception of the venue.

In another aspect, the user is provided with a limited period of time to provide the real time review and/or the real time rating otherwise a time limit expires and a verification process of the geographical location of the user occurs again.

In another aspect, the location aware smart computing device comprises a global positioning system (GPS) that is used to obtain a particular location of the user and compare to the geographical location of the particular venue.

In another aspect, the geographical location of the user is obtained using geofencing as determined by the one or more processors of the location-aware smart computing device. The geofencing may comprise creating a virtual boundary or fence in the computer application and/or an integrated third party application dedicated to operate as a geographical information system (GIS) around the established geographical location of the particular venue. Further, the virtual boundary or fence is monitored by the computer implemented application and/or the integrated third party application to determine whether the location-aware smart computing device crossed the virtual boundary or the fence. If it is determined that the location-aware computing device crossed the virtual boundary or the fence, the computer implemented application affirmatively establishes a presence of the location smart geographic device within the acceptable geographical range of the established geographic location of the particular venue.

In another non-limiting embodiment, the geographical location of the user is obtained by receiving QR code data specific to the particular venue from QR codes, wherein the QR codes are only scannable if the user is at the particular venue and are available only during certain time periods.

Further, in another aspect, the geographical location of the user may alternatively be obtained by using one or more Bluetooth beacons positioned at the particular location. The one or more Bluetooth beacons transmits a signal to the location-aware smart computing device and an ID number that is transmitted to a monitoring server, whereby the monitoring server verifies whether the ID number is assigned to the one or more Bluetooth beacons positioned at the established geographical location of the venue. Subsequently, the monitoring server transmits a response to the computing application in response to the determination made by the one or more processors of the location aware smart computing device whether the geographical location of the user is within the acceptable geographical range from the established geographical location and range for the particular venue.

In another aspect, one or more RFID tags are associated/attached to a computing device to help determine whether the user's location matches with an established geographical location of the particular venue and are used to determine the geographical location of the user.

In another aspect, the computer implemented application may further comprise a venue resolution response module integrated in the computer implemented application that notifies a venue of the real time review and/or the real time rating prior to allowing a user to publish the real time review and/or the real time rating, and allows the venue an opportunity to respond to the user via the computer implemented application to fix or improve a user's experience at the venue prior to publication of the user's real time review or the real time rating on the computer implemented application for other users to view.

In another aspect, the computer implemented application further comprises a module for creating an area map, whereby the area map is a virtual rendering of one or more venues in a particular area. The area map may further include virtual icons associated with the one or more venues as displayed on the area map. Further, any reviews or ratings provided by the user and other users of the computer implemented application are viewable to the user on the computer implemented application from the area map.

In another aspect, the computer implemented application sends notifications to the user of potential venue recommendations based on the user preferences, including a preferred venue ranking and/or preferred venue rating, whereby a machine learning module is integrated into the computer implemented application and includes a series of layers to map variables to determine the potential venue recommendations and suggest a relevant set of the potential venue recommendations.

In another aspect, the computer implemented application comprises a module for a user to associate an interactive virtual avatar with a user profile of the user. The interactive virtual avatar is configured to interact with graphical icons that indicate a level of crowdedness, activity, and energy associated with the particular venue on a virtual area map as displayed on the computer implemented application. Further, the graphical icons are affected by group ratings and reviews as provided by users of the computer implemented application.

Other aspects and advantages of the invention will be apparent from the following description and the appended claims.

### BRIEF DESCRIPTION OF THE DRAWINGS

The preceding and following embodiments and descriptions are for illustrative purposes only and are not intended to limit the scope of this disclosure. Other aspects and advantages of this disclosure will become apparent from the following detailed description.

Embodiments of the present disclosure are described in detail below with reference to the following drawings. The drawings described herein are for illustrative purposes only of selected embodiments and not all possible implementations and are not intended to limit the scope of the present disclosure.

FIG. 1 is a block diagram depicting computing devices, components, and systems for implementing one or more functions of a computer implemented application.

FIG. 2 is another block diagram of components of a computer implemented application in accordance with an illustrative embodiment.

FIG. 3 is a block diagram of components of the computer implemented application in accordance with an illustrative embodiment.

FIG. 4 is a pictorial illustration of an interface for an interactive virtual avatar displayed in actual surroundings of a user as displayed virtually in the computer implemented application.

FIG. 5 is a pictorial illustration of the interface shown in FIG. 4 in which the virtual avatar is engaging with the virtual representation of the reviews for a venue.

FIG. 6 is a flowchart depicting a method of using a computer implemented experience application for receiving real-time accurate reviews and/or ratings of a particular venue.

### DETAILED DESCRIPTION

The present embodiments are directed to one or more computer implemented systems and methods for using a computer implemented application that has multiple functions and features related to user reviews for venues or other services or products available at a venue. Further, the computer implemented application includes a system for provided real live representation of the amount of people that utilize the computer implemented application and the amount of real time and live streams coming from a certain establishment or venue. The computer implemented application allows users to view in real time which establishments in a specific zip code or other region or area are currently active, lively, and/or have a large group of people attending the establishment for the user to get a sense if this venue is well-attended or not. Further, the computer implemented application provides a feature in which a virtual avatar can engage with maps of the area that the user is located in, and the virtual avatar may engage with unique icons and graphics associated with real time reviews that other users of the computer implemented application have recently or previously provided for a venue.

Further, the computer implemented application may also allow users to take trips to chosen specified destinations whereby a driver of a car transportation service or company may connect with the customer database of the computer implemented application and be able to see what destination the user intends to be taken to without necessarily having spoken with the customer. Rather, the driver from the car transportation service and vehicle is automatically provided with one or more intended addresses and/or names of venues the user wishes to be taken to based on information provided from the computer implemented application. Further, the computer implemented application may allow a user to have a generic vehicle dashboard or a virtual dashboard associated with specific vehicles having a particular make, model, and appearance of the user's choice, in which as the user travels to their destination, the virtual dashboard is displayed on the user's computing device via the application and may further include a music streaming services. Other benefits and advantages are described further below with respect to the Figures.

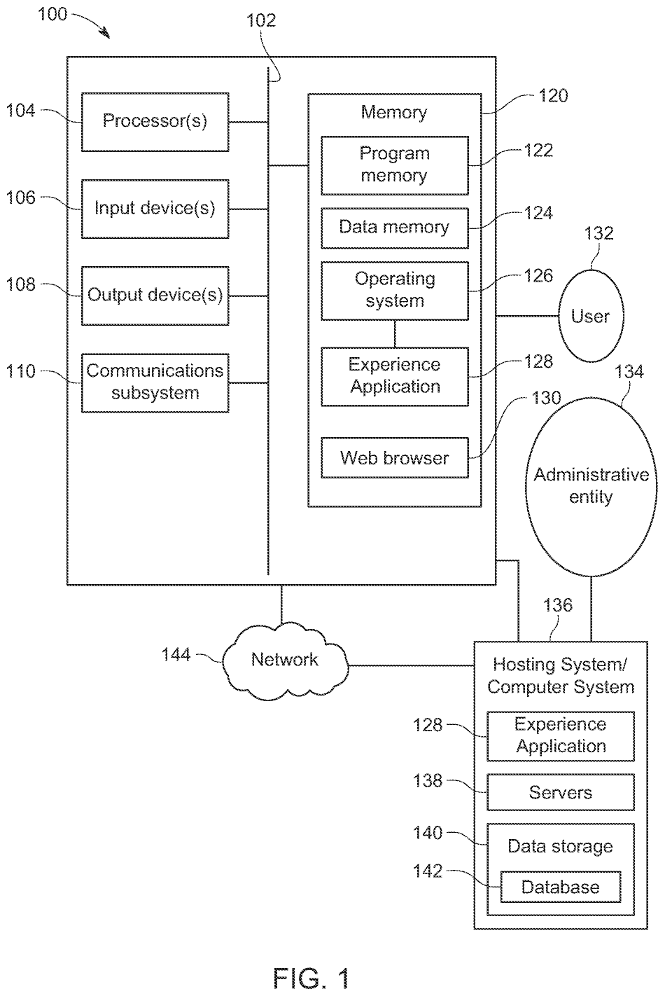

Turning to FIG. 1, FIG. 1 illustrates an exemplary system for one or more computing devices and the various exemplary components that may be employed in practicing one or more non-limiting embodiments of the invention as described herein. Computing device 100 may be any type of computing device known or to be created in the future. This may include, without limitation, fixed in place computers, such as desktop computers or mobile computing devices. Mobile computing devices may include, but are not limited to, laptop computers, smartphones and mobile phones, tablets, wearable electronic computing devices such as watches or glasses, or any other type of mobile electronic, computing device.

FIG. 1 provides a schematic illustration of one embodiment of a computing device 100 that can perform the methods provided by the various other listed embodiments, as described herein, and/or can function as the host computer system, a remote kiosk/terminal, a point-of-sale device, a mobile device, a set-top box and/or a computer system. FIG. 1 is meant only to provide a generalized illustration of various components, any or all of which may be utilized as appropriate. FIG. 1, therefore, broadly illustrates how individual system elements may be implemented in a relatively separated or relatively more integrated manner.

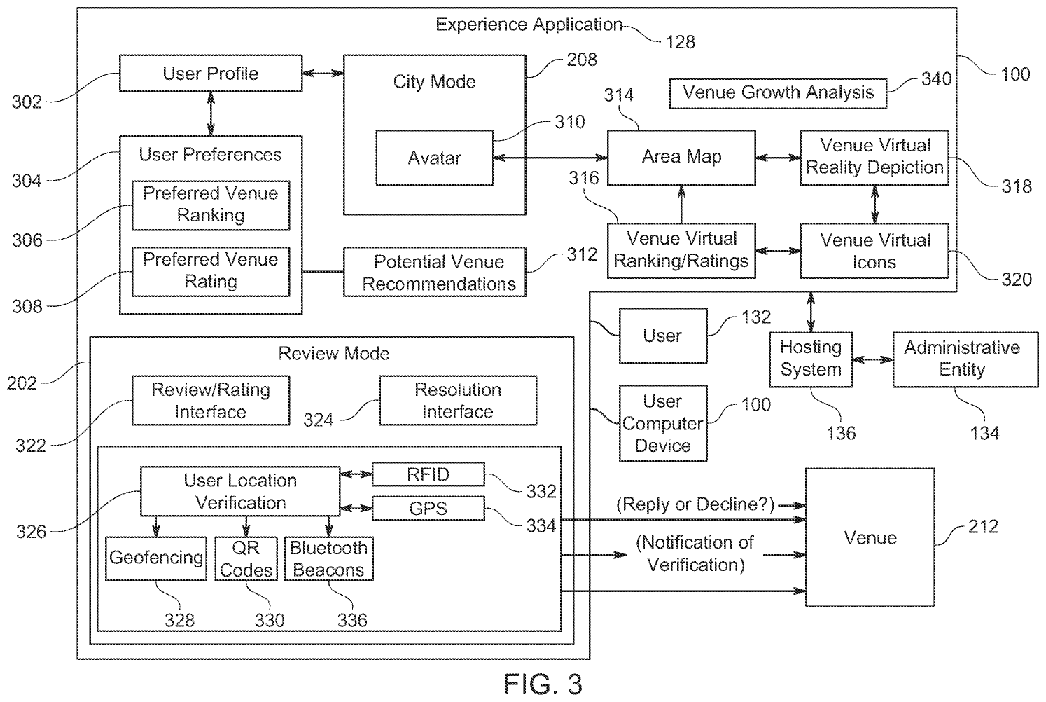

Computing device 100 may be any type of information handling system, including, but not limited to, any type of computing device as noted above. Notably, computing device 100 is a smart computing device that is a location aware type of computing device. Accordingly, computing device 100 incorporates a global positioning system (GPS) 334 (e.g., as shown in FIG. 3) in one or more non-limiting embodiments. Further, computing device 100 incorporates BLUETOOTH connectivity in one or more non-limiting embodiments. As further elaborated upon in FIG. 3, it may be necessary to track and verify a location of a computing device 100 and compare to a location of a venue 212, and it may be necessary to rely on elements of either the user's GPS system 334 and/or BLUETOOTH connectivity to do so.

To reiterate, this may include small handheld devices, such as handheld computer/mobile telephones or may include large mainframe systems, such as a mainframe computer. Further examples of handheld computing devices may include personal digital assistants (PDAs), personal entertainment devices, such as MP3 players, portable televisions, and compact disc players. Other examples of computing devices 100 may include, but are not limited to, laptops, notebooks, workstation computers, personal computer systems, as well as servers (e.g., servers 138). Computing devices 100 can be used by various parties described herein and may be connected on a computer network, such as computer network 144. Types of computer networks that can be used to interconnect the various information handling systems may include, but are not limited to, Local Area Networks (LANs), Wireless Local Area Networks (WLANs), the Internet (e.g., World Wide Web), the Public Switched Telephone Network (PSTN), other wireless networks, and any other network topology that can be used to interconnect the information handling systems.

The computing device 100 is shown comprising hardware elements that can be electrically coupled via a bus 102 (or may otherwise be in communication, as appropriate). The hardware elements of computing device 100 may include one or more processors 104, including without limitation one or more general-purpose processors and/or one or more special-purpose processors (such as digital signal processing chips, graphics acceleration processors, and/or the like). Computing device 100 may further include one or more input devices 106, which can include without limitation one or more cameras, sensors (including inertial sensors), a mouse, a keyboard and/or the like, which may be utilized in the implementation of experience application 128.

In addition to the above, computing device 100 may include one or more output devices 108 such as the device display. Furthermore, in some embodiments, an input device 106 and an output device 108 of computing device 100 may be integrated, for example, in a touch screen or capacitive display as commonly found on mobile computing devices as well as desktop computers and laptops.

Processors 104 may have access to a memory such as memory 120. Memory 120 may include one or more of various hardware devices for volatile and non-volatile storage and may include both read-only and writable memory. For example, memory 120 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory 120 is not a propagating signal divorced from underlying hardware; a memory is thus non-transitory. Memory 120 may include program memory such as program memory 122 capable of storing programs and software, such as an operating system such as operating system 126, experience application 128, and other computerized programs or application programs. Memory 120 may also include data memory such as data memory 124 that may include database query results, configuration data, settings, user options or preferences, etc., which may be provided to program memory 122 or any element of computing device 100.

The computing device 100 may further include (and/or be in communication with) one or more non-transitory storage devices, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like. Device storage may be used in a number of embodiments discussed herein. Further, the storage devices may be non-volatile data storage devices in one or more non-limiting embodiments. Further, computing device 100 may be able to access removable nonvolatile storage devices that can be shared among two or more information handling systems (e.g., computing devices) using various techniques, such as connecting the removable nonvolatile storage device to a USB port or other connector of the information handling systems.

The computing device 100 might also include a communications subsystem 110, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 110 may permit data to be exchanged with a network (e.g., such as network 144), other computer systems, and/or any other devices.

The computing device 100 also can comprise software elements, shown as being currently located within the memory 120, which in some instances may include an operating system 126, device drivers, executable libraries, and/or other code, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer). In an aspect, then, such code and/or instructions can be used to configure and/or adapt computing device 100 to perform one or more operations in accordance with the described methods.

A set of these instructions and/or code might be stored on a computer-readable storage medium, such as the storage device(s) described above. In some cases, the storage medium might be incorporated within a computer system, such as computing device 100. In other embodiments, the storage medium might be separate from computing device 100 (e.g., a removable medium, such as a compact disc or USB stick), and/or be provided in an installation package, such that the storage medium can be used to program, configure, and/or adapt a general-purpose computer with the instructions/code stored thereon. These instructions might take the form of executable code, which is executable by the computing device 100 and/or might take the form of source and/or installable code, which, upon compilation and/or installation on the computing device 100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computing device 100) to perform methods in accordance with the disclosure. For example, some or all of the procedures of the described methods may be performed by the computing device 100 in response to one or more processors 104 executing one or more sequences of one or more instructions (which might be incorporated into the operating system 126 and/or other code contained in the memory 120). Such instructions may be read into the memory 120 from another computer-readable medium, such as one or more of the storage device(s). Merely by way of example, execution of the sequences of instructions contained in the memory 120 may cause the one or more processors 104 to perform one or more procedures of the methods described herein.

The terms “machine-readable medium” and “computer-readable medium,” as used herein, refer to any medium that participates in providing data that causes a machine to operate in a specific fashion. In an embodiment implemented using the computing device 100, various computer-readable media might be involved in providing instructions/code to the one or more processors 104 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media may include, for example, optical and/or magnetic disks which may be an example of storage devices. Volatile media may include, without limitation, dynamic memory, which may be a type of memory included in memory 120. Transmission media may include, without limitation, coaxial cables, copper wire and fiber optics, including the wires that comprise the bus 102, as well as the various components of the communications subsystem 110 (and/or the media by which the communications subsystem 110 provides communication with other devices). Transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 104 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 100. These signals, which might be in the form of electromagnetic signals, acoustic signals, optical signals, and/or the like, are all examples of carrier waves on which instructions can be encoded, in accordance with various embodiments of the invention.

The communications subsystem 110 (and/or components thereof) generally will receive the signals and the bus 102 then might carry the signals (and/or the data, instructions, etc. carried by the signals) to the memory 120 from which the one or more processors 104 retrieves and executes the instructions. The instructions received by the memory 120 may optionally be stored on a non-transitory storage device either before or after execution by the processor(s) 104.

In one or more embodiments, computing device 100 is in communication with one or more networks, such as network 144. Network 144 may include a local area network (LAN), such as a company Intranet, a metropolitan area network (MAN), or a wide area network (WAN), such as the Internet or World Wide Web. Network 144 may be a private network, a public network, or a combination thereof. Network 144 may be any type of network known in the art, including a telecommunications network, a wireless network (including Wi-Fi), and a wireline network. Network 144 may include mobile telephone networks utilizing any protocol or protocols used to communicate among mobile digital computing devices (e.g., computing device 100), such as GSM, GPRS, UMTS, AMPS, TDMA, or CDMA. In one or more non-limiting embodiments, different types of data may be transmitted via network 144 via different protocols. In further non-limiting other embodiments, computing device 100 may act as a standalone device or may operate as a peer machine in a peer-to-peer (or distributed) network environment.

Network 144 may further include a system of terminals, gateways, and routers. Network 144 may employ one or more cellular access technologies, including but not limited to: 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between computing devices if, for instance, they are in a remote location not accessible by other networks.

In one or more non-limiting embodiments, a computing device, such as computing device 100 may include a web browser such as web browser 130. Web browser 130 may be any type of web browser known in the art that may be used to access one or more web applications (e.g., experience application 128) on user computing devices 100 or the like. Web applications are applications that are accessible by network 144 and may be located on the Internet or World Wide Web. Web browser 130 may include a variety of hardware, software, and/or firmware generally operative to present a web application to a user via a display device 108 (e.g., touchscreen or other type of monitor or display device) on a computing device. Examples of suitable web browsers include, but are not limited to, MICROSOFT EXPLORER, MOZILLA FIREFOX, and APPLE SAFARI. Web browser 130 may be previously installed by the manufacturer or company associated with the computing device 100, or alternatively, may be downloaded onto computing device 100 or any other computing device. Web browser 130 may be stored in a separate storage device and/or memory 120.

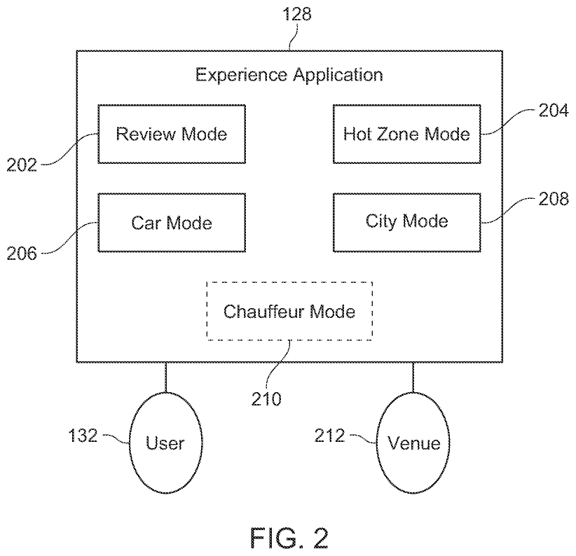

In one or more non-limiting embodiment, experience application 128 may be a software program or module configured to provide real time reviews, ratings, and/or virtually representations/indications of the activity level in real time at a venue such as venue 212 as shown in FIG. 1 and in FIG. 2. Further, the experience application 128 may be a software program or module that allows users 132 to be transported to particular destinations and venues 212, whereby the experience application 128 is linked with a car transportation service that can view the venues 212 of interest to a user 132 and automatically schedule or otherwise engage with the user to transport the user 132 to the one or more of these destinations specified via the experience application 128. Further, experience application 128 may have a mode in which a virtual avatar (e.g., virtual avatar 310 as shown in FIGS. 3-5) that represents the user is shown on the output device 108 (e.g., display screen) of the user 132's computing device 100 and the virtual avatar 310 can interact with icons and graphics for venues 212 represented in the virtual world shown in the experience application 128 in order to obtain real time reviews about the venue 212. Further, the experience application 128 can provide a virtual dashboard and/or steering wheel as shown on the display screen 108 of the user 132's computing device 100 that the user 132 may view and may access music streaming services from this interface in the experience application 128 in one or more non-limiting embodiments.

In one or more non-limiting embodiments, experience application 128 may be implemented as a web service. As known in the art, a web service may be a software module or software program (e.g., experience application 128) that is designed to implement a set of tasks that is accessible from multiple computing devices, such as computing device 100 over a network, such as network 144. In particular, experience application 128 may be implemented as a web service accessible using the World Wide Web as the connecting network 144, although any alternative type of network may be used. Experience application 128, when implemented as a web service, can be searched by any user (e.g., user 132) using web browser 130. Experience application 128 when implemented as a web service can be searched for over the network 144 using the input devices 106 of a computing device and can also be invoked accordingly. Further, experience application 128 when invoked as a web service would be able to provide functionality to the client or user which invokes that web service.

When experience application 128 is implemented as a web service, a client or party may invoke a series of web service calls via requests to one or more servers 138 that are part of the hosting system 136 which would host the actual web service. In one or more non-limiting embodiments, hosting system 136 may be a cloud-based type hosting system. “Cloud-based” is a term that refers to applications, services, or resources (e.g., experience application 128) made available to users on demand via a network, such as network 144, from a cloud computing provider's server. In one non-limiting embodiment, administrative entity 134 may be the cloud computing provider and may use servers 138 to provide access to experience application 128.

Hosting system 136 may include data storage systems 140 that can provide access to stored data by applications running on computing devices (e.g., 100) that may be geographically separate from each other, provide offsite data backup and restore functionality, provide data storage to a computing device with limited storage capabilities, and/or provide storage functionality not implemented on a computing device (e.g., 100).

The hosting system 136 may be a service that can be implemented as a web service, in one or more non-limiting embodiments, with a corresponding set of Web Service Application Programming Interfaces (APIs). The Web Service APIs may be implemented, for example, as a Representational State Transfer (REST)-based Hypertext Transfer Protocol (HTTP) interface or a Simple Object Access Protocol (SOAP)-based interface. Any programming languages may be used to create or operate experience application 128 as a web service, including, but not limited to .Net, Java, and XML. Further, experience application 128 as a web service may use standardized industry protocol for the communication and may include well-defined protocols, such as Service Transport, XML Messaging, Service Description, and Service Discovery layers in the web services protocol stack.

For instance, the hosting system can be implemented such that client applications (for example, executing on computing device 100) can store, retrieve, or otherwise manipulate data objects in the hosting system 136. The hosting system 136 can be implemented by one or more server devices 138, which can be implemented using any type of computing device.

In one or more non-limiting embodiments, administrative entity 134 is the provider and creator of experience application 128. Administrative entity 134 may provide the application programming interface (e.g., experience application 128) for use by user 132. Administrative entity 134 may be able to manipulate and alter experience application 128 to affect the operation and maintenance of experience application 128 on server(s) 138 and as stored on one or more data storage devices 140 that are part of the hosting system 136. Data storage devices 140 included for storing any data associated with experience application 128 may include one or more databases 142 that store live and historical sensor data in one or more non-limiting embodiments. While administrative entity 134 is depicted as a single element communicating over network 144 and through the hosting system 136, it is noted that administrative entity 134, in one or more non-limiting embodiments, may be distributed over network 144 in any number of physical locations.

In one or more non-limiting embodiments, experience application 128 may alternatively be a downloadable software module that is capable of being stored directly on a computing device, such as computing device 100, rather than acting as a web service accessible through a computing device's web browser 130. Accordingly, any user may be able to download, and store experience application 128 on computing device 100 as a computer-based application and software module that runs using the working engines and modules on the computing device. In some embodiments, experience application 128 may be preinstalled on computing device 100 or any other computing device by the manufacturer or designer or other entity. Experience application 128 may be innate, built into, or otherwise integrated into existing platforms such as, without limitation thereto, a website, third-party program, iOS™, Android™, Snapchat™, Getty Images™, Instagram™, Facebook™, or any other platform capable of transmitting, receiving, and presenting data.

Experience application 128 may be stored on computing device 100 or any other computing devices and may also be stored or otherwise accessible by one or more servers 138 over network 144 by any party. The storage devices may include a non-transitory computer readable medium including instructions, which when executed by a computer or processor (such as processors 104) may cause the computer or processor to perform operations to implement experience application 128. Additionally, or alternatively, experience application 128 may be a software application that is downloadable and usable from any type of mobile computing device 100.

As shown in FIG. 1, computing device 100 may belong to a user referred to in FIG. 1 such as user 132. User 132 may be a user that intends to access experience application 128 using his or computing device 100.

As noted above, in one non-limiting embodiment, experience application 128 may be implemented as a web service as described above. Accordingly, experience application 128 may be accessed by any party, including user 132, over the computer network 144 using their web browsers 130 to view one or more features included with experience application 128. Further information about other components of experience application 128 are included below with respect to FIGS. 2-6.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

FIG. 2 is a block diagram depicting one or more functions and features of experience application 128. Experience application 128 is a downloadable or otherwise accessible application that may be used on the one or more computing devices 100 of a user 132.

In a non-limiting embodiment, the experience application 128 includes one or more interfaces for a review mode 202 with relevant features and functions. Review mode 202 may be a part of the experience application 128 in which the users 132 may leave accurate, real time reviews that are vetted, may access other reviews to determine whether to attend or visit a venue 212, and/or obtain one or more services or products offered at the venue 212.

In a non-limiting embodiment, the review mode 202 may allow only users 132 with proof of attendance to venue 212 to leave an online review or a review that is accessible via the experience application 128. In a non-limiting embodiment, a number of location estimation technologies as provided and shown in FIG. 3 may be used to verify a user's location, including but not limited to, geofencing 328, QR codes 330, Bluetooth beacons 336, RFID tags 332, as well as systems utilizing the GPS 334 on a user computing device 100.

Any reviews left on the review mode 202 interfaces of the experience application 128 may be visible to other users 132 of the experience application 128 from any computing device 100. The reviews should be verified by having an associated QR code as noted above, and further will be dated so the user 132 can see exactly when the reviews was left. Further, in a non-limiting embodiment, the reviews may be removed after a period of time, such as a couple of days to one week. In this way, users 132 are not forced to rely on older reviews that may no longer be relevant, but rather can view relevant reviews of venue 212 that are more recent and reflect a more realistic picture of the venue 212, including the activity level, energy, and satisfaction of attendees from a more recent period of time.

In a non-limiting embodiment, once the user 132 attends a venue 212, the experience application 128 may be configured to check in automatically and to mark the user 132's location. Further, the experience application 128 may in the background verify that the user 132 is within the perimeters of the venue or establishment 212. The experience application 128 may begin the verification time as soon as the user 132 either actively checks in via the experience application 128 or is automatically checked in by the experience application 128 having been preprogrammed to recognize that the user 132 has arrived at a particular venue 212. The experience application 128 may then remind the user 132 that the user 132 is verified to make a review and it can choose from a variety of types of reviews. The experience application 128 may further be configured to have a limited period of time for a user 132 to make or leave a review of venue 212 after leaving the perimeter of the venue 212. Accordingly, the user 132 may have a limited time frame or window of time to make a legitimate review that meets the standards of the experience application 128.

For example, in a non-limiting embodiment, the experience application 128 may enable the user 132 to leave a 1) real time review, 2) live stream review, 3) weekly ranking, and/or a 4) food and drink review. Real time reviews may relate to a type of review whereby the user 132 selects a specific icon or graphic that indicates how exciting, active, and lively is the venue 212. Another term for exciting, active, and lively may be how “popping” or “lit” is the venue 212. For example, in a non-limiting embodiment, the user 132 may be able to choose from four different indications or icons including 1) a graphical symbol of an intense flaring flame which means that the venue 212 is very active and exciting, 2) a graphical symbol of a glowing flame which means that the venue 212 is slightly busy, 3) a graphical symbol of a smoldering coal which means that the venue 212 is slow and below average the normal activity level, and 4) a graphical symbol for cross bones or a skull which means that the venue 212 does not have any sense of activeness or exciting activities currently being held and is dead. These graphical symbols are visible in the review mode 202 interfaces of the experience application 128 and may be selected using the input devices 106 (e.g., touchscreen, mouse, keyboard) of the user 132's computing device 100.

In a non-limiting embodiment, a live stream review may comprise of a picture or a short streaming video, similar to the streaming videos taken using SNAPCHAT, that can be immediately uploaded and may be visible from a variety of locations, including being visible on the experience application 128 for other users 132 to view and/or other websites, including social media websites such as FACEBOOK, INSTAGRAM, WHAT'S APP, or any other website or application. Verified live stream revies will be able to be seen immediately by users 132, and will stay in the database 142 (e.g., as shown in FIG. 1) of the experience application 128 at least 24 hours in a non-limiting embodiment before being erased. In this manner, the experience application 128 requires reviews to be verified and also to only be visible for a very limited period of time so that users 132 are constantly provided with a most recent review, and not forced to rely on reviews that have been left a long time prior to the time or date a user 132 wants to attend a venue 212 or experience a service or product.

Another type of review as mentioned above a user 132 may provide via the experience application 128 is the weekly ranking review. In the weekly ranking review, the user may select a graphical icon to indicate how exceptional or good the venue 212 was to attend and may provide a level of satisfaction and happiness by the user 132 with the venue 212. In a non-limiting embodiment, the graphical symbols may include a series of flames, and the user 132 can choose to leave one flame for very poor service or poor level of satisfaction at a venue 212 all the way to five flames to indicate that the user 132 was very happy and very satisfied with the user 132's experience at the venue 212. The weekly ranking review may be uploaded and/or visible in the experience application 128 for a limited period of time in a non-limiting embodiment, such as for a week or two weeks, and then removed after that period of time.

The review mode 202 may further allow the user 132 to provide any type of food and drink review that relates to food or drinks provided by venue 212. In a non-limiting embodiment, in order to first verify the authenticity of the user 132's experience with a food or drink and before being able to leave such a food and drink review, the user 132 may have to scan a QR code 330 provided from a unique location or item associated with a venue 212. For example, the QR code 330 may only be available on a receipt of a user 132 after receiving the user 132's meal and/or drinks. Alternatively, the QR code 330 may only be available from a table or checkout stand at the venue 212. Ultimately, the review is verified for authenticity by verifying that the user 132 did order the food and drink that will be potentially described and discussed in a review and the particular period of time that the user 132 asserts the food and drink were provided.

The method provided herein for having verification and authentication before a user 132 is allowed to leave a review about a venue 212 and/or a review about services or products provided by the venue 212 should help cause a significant reduction of review site fraud by any establishment. The ability to make fraudulent reviews whether negative or positive will be immensely decreased if not diminished using the one or more methods and steps described above with respect to the review mode 202 of the experience application 128.

Another mode or feature offered by the experience application 128, as shown in FIG. 2, is the hot zone mode 204. In a non-limiting embodiment, the hot zone mode 204 may comprise a map-like design of the user 132's area and may include graphical icons to indicate any venues 212 within that area having a high ranking or rating according to the real time reviews and live stream views provided from users 132 associated with the experience application 128. There may be two factors for the basis of data for density and concentration within a specific area. These two factors may include, but are not limited to 1) the number of users 132 and/or other people associated with the experience application 128 and 2) the amount of real time reviews and live stream reviews being provided from a particular venue 212.

In a non-limiting embodiment, there may be designated area associated with a user 132 that the user 132 may set up in experience application 128 in the user 132's personal profile and preferences. This designated area may have a changeable radius that is set around a user 132's location. An interface of the experience application 128 may include a circle indicating the boundaries of the specified radius with an indication of a level of activity in the specified radius with respect to the user 132 (or with respect to another reference point as set by the user 132). The level of activity may be color coded so that the lighter colored area of the circle may mean that this area is less dense in terms of numbers of users 132 using or having experience application 128 (e.g., a less dense area) at any venues 212 in this area, and a darker colored area may mean that there is a greater number of users 132 using or having experience application 128 (e.g., a denser area). In one embodiment, the user 132 will be able to zoom in to a specified area and view any venues 212 that have current reviews, including live streaming and/or weekly ranking reviews, including the graphical icons and symbols such as “Lit” or the five fire icons when a customer is very pleased with the service and/or venue 212. As noted above, the reviews are preferably provided from a very recent period of time and have been verified as being accurate and authentic to an actual customer or user 132 who has been serviced and/or attended a venue 212. The user may be enabled, in the hot zone mode 204, to select directions to the venue 212 whose review is included in experience application 128 and appeals to the user 132 using any type of third-party mapping application (e.g., WAZE or GOOGLE MAPS).

Car mode 206 may be a graphical interface included in the experience application 128 with a virtual car and/or virtual dashboard displaying various imagery that may be appealing to the user 132 when the user 132 is traveling to the venue 212. In a non-limiting embodiment, the user may be able to select car mode 206 when traveling to a chosen, specified destination selected initially from the hot zone mode 204 included in the experience application 128. The specific address of the venue 212 may be chosen from the main directory of the experience application 128 or may be displayed along with the reviews of the venue 212. In the car mode 206, there may be a graphical display shown in one or more interfaces of the experience application 128 displaying a virtual dashboard from a vehicle. In a non-limiting embodiment, the virtual dashboard from the vehicle may include a virtual display for a steering wheel, speedometer, radio, windshield, and a rear-view mirror. Any features of the virtual dashboard as graphically displayed may be upgraded by the user 132 within the experience application 128 either for free or for purchase. The virtual dashboard may be altered as desired by the user and further the user 132 can vary the type of vehicle and virtual dashboard displayed on the computing device 100 and from the experience application 128.

In a non-limiting embodiment, the user 132 can view any real-life surroundings shown in three dimensions (3D) through a virtual windshield while the user 132 is traveling to the original destination (i.e., venue 212) which may have been selected first in the hot zone mode 204 in one or more non-limiting embodiments. Further, any visual scenes may be shown in a virtual world from a graphically displayed front windshield associated with the virtual dashboard. The graphically displayed virtual rear-view mirror may capture and reflect potential spots that the user 132 may want to visit after the user 132 proceeds to the venue 212.

On the way to the venue 212, the user 132 may be alerted of other venues similar to the selected venue 212 that the user 132 is headed to. These other venues may be considered similar by the experience application 128 based on criteria obtained from the user 132's preferences. The experience application 128 may suggest other similar venues or locations and the user 132 may select from a particular list of other venues and select a different destination if desired. Further, the other presented options for different venues may be stored in the experience application 128 for later consideration by the user. In a non-limiting embodiment, the other presented options may be selectable from an enlargeable graphic icon visible in the virtual dashboard of the car mode 206.

It is noted that any time the user 132 may interact with any of the modes 202-210 of the experience application 128 via any type of input, including written instructions or audio/spoken commands. As a safety measure, the user 132 may also communicate with the experience application 128 when driving only in spoken/audio commands that the experience application 128 may process to execute one or more features or functions available with the experience application 128. For example, if the user 132 chooses an alternative suggested destination provided in car mode 206, the user 132 may select to reroute to that suggested destination such that the virtual surroundings 318 presented in the virtual dashboard become altered and the mapping features of the experience application 128 are automatically altered to reflect driving directions to the alternative destination.

In another embodiment, the virtual dashboard may include a virtual radio that the user 132 may select to hear music from the user 132's computing device 100. Such music may be prerecorded music files or may be music selected from a music streaming service that may be available for a user to purchase as part of a subscription. Such music streaming services may include, but are not limited to, SPOTIFY, APPLE ITUNES, etc.

The city mode 208 is another functional mode of experience application 128 in one or more non-limiting embodiments. The city mode 208 includes a virtual avatar 310 associated with each user 132. The appearance of the virtual avatar 310 may be altered and varied by the user 132 as desired. In a non-limiting embodiment, the virtual avatar 310 may appear three-dimensional (3D).

The user 132 may be able to vary the appearance of the virtual avatar 310 by purchasing various additional optional outfits, accessories, or appearances in the experience application 128. In city mode 208, the virtual avatar 310 will appear to follow and mirror the movements and motions as the user 132 in real life and within the virtual visualization displayed from the display device of the user 132's computing device 100.

Accordingly, as the user 132 walks around a particular area or is at the venue 132, the virtual avatar 312 is also shown doing the same in the virtual world or scene or area map 314 displayed in city mode 208 in the experience application 128. The user 132 may be presented with various graphical icons, which were described above with respect to review mode 202. Accordingly, there may be graphical icons shown in the city mode 208 that are associated with indicating how busy and lively and fun or otherwise entertaining the user 132 believes the venue 212 to be based the user 132's actual physical presence at the venue 212 at a particular time. The graphical icons may include, but are not limited to, 1) an intensely flaring flame which means that the venue 212 is very busy and active, 2) a glowing flame which means the venue 212 is slightly busy, 3) a smoldering coal which means that the venue 212 is rather slow and has a below average level of activity, and 4) cross bones or skulls which means that there is little to no activity of interest at the venue 212 and that the venue 212 is not very crowded or active. Any live stream reviews, real time reviews, and weekly review ratings for the venue 212 may be accessible and viewable in the review mode 202 of the experience application 212 in one or more non-limiting embodiment. The graphic icons associated with 1) an intensely flaring flame, 2) a glowing flame, 3) a smoldering coal, and 4) cross bones or skull may appear to levitate and bounce around or jump around the screen of the computing device 100 in order to visually engage with the user 132 in one or more non-limiting embodiments. Each venue 212 will be represented by one of the four graphically displayed icons with their particular rankings and meanings as described above. There may be a display that describes the number of rankings provided over a certain period of time. The notifications and rankings displayed graphically above or near the virtual representation of the venue 212 may be a clear signal and indication to the user 132 of how active and busy the venue 212 is at a designated time of day or night and in real time.

In a non-limiting embodiment, the graphically displayed (possibly levitating) notifications or graphical icons may linger in the city mode 208 virtual world until the user 132 either swipes on an icon or otherwise interacts with the icon. The user 132 may also be required to “walk” or otherwise move around the virtual world in the city mode 208 in order to view enough notifications, reviews, and ratings for the venue 212. In the city mode 208, multiple forms of advertisements may be provided and displayed to the user 132, but the user 132 may elect to not view advertisements and toggle on and off as needed.

The chauffeur mode 210 may be either integrated with the experience application 128 or may be an entirely separate application from the experience application 128 in one or more non-limiting embodiments. The chauffeur mode 210 allows the intended destination of the user 132 for a venue 212 or any other location to be visible to one or more car transportation services, such as, but not limited to, UBER or LYFT, taxicab services, and/or any of their drivers. The drivers can then automatically select to pick up a user 132 from one location and take to a particular venue 212 indicated by the user 132 via the experience application 128. The chauffeur mode 210 facilitates the coordination between the user 132 and the car transportation company to schedule the pickup and drop off with minimal requirement on the user 132's part to verbally communicate with a driver, because there may be misunderstandings in terms of the address and intended destination when this happens. The driver or chauffeur of the car transportation service is able to view exactly which destination or destinations a user 132 is interested in going to and can choose to take the user 132 to a single destination or multiple destinations over an arranged period of time using the chauffeur mode 210.

In addition to the above, there may be multiple options to purchase as needed or based on a subscription model one or more virtual cars, choice of popular music streaming applications, and avatar personalization as noted above for each of the hot zone mode 204, car mode 206, and city mode 208.

Turning to FIG. 3, FIG. 3 shows a block diagram of more detailed components that relate to the experience application 128, review mode 202 and city mode 208 according to one or more non-limiting embodiments. In a non-limiting embodiment, each user 132 may have a user profile 302. The user profile 302 may include or relate to a number of factors including allowing a user 132 to list and rank user preferences 304 as they relate to venues 212 of interest to the user 132. Accordingly, the user 132 can describe or respond to a series of questions about desirable qualities, characteristics, and/or features that the venues 212 should provide. In a non-limiting embodiment, the venues 212 are types of venues that relate to nightlife related venues, such as, but not limited to, bars, clubs, restaurants, concert halls, or the like. However, there is no requirement that only night life related venues 212 may be listed and the experience application 128 may relate to any and all types of venues 212 providing different types of services, products, and experiences.

The user preference 302 as included in the user profile 302 of the experience application 128 or other module of the experience application 128 may further provide a preferred venue ranking 306 and/or preferred venue rating 308 that a venue 212 may have. As shown in FIG. 3, in a non-limiting embodiment, the user 132 may suggest potential venue recommendations 312 to the user 132 based on a comparison of the rankings, reviews, ratings of the venue 212 and the user's preferred venue ranking 306 and the user preferred venue rating 308. In a non-limiting embodiment, a machine learning module is integrated into the experience application 128 and includes a series of layers to map variables to determine the potential venue recommendations 312 and suggest a relevant set of the potential venue recommendations 312. The machine learning model can take data obtained from a variety of users to compare and contrast based on user preferences 304 which venues 212 match the desired criteria for suggesting a set of relevant potential venue recommendations 312 for a user 132.

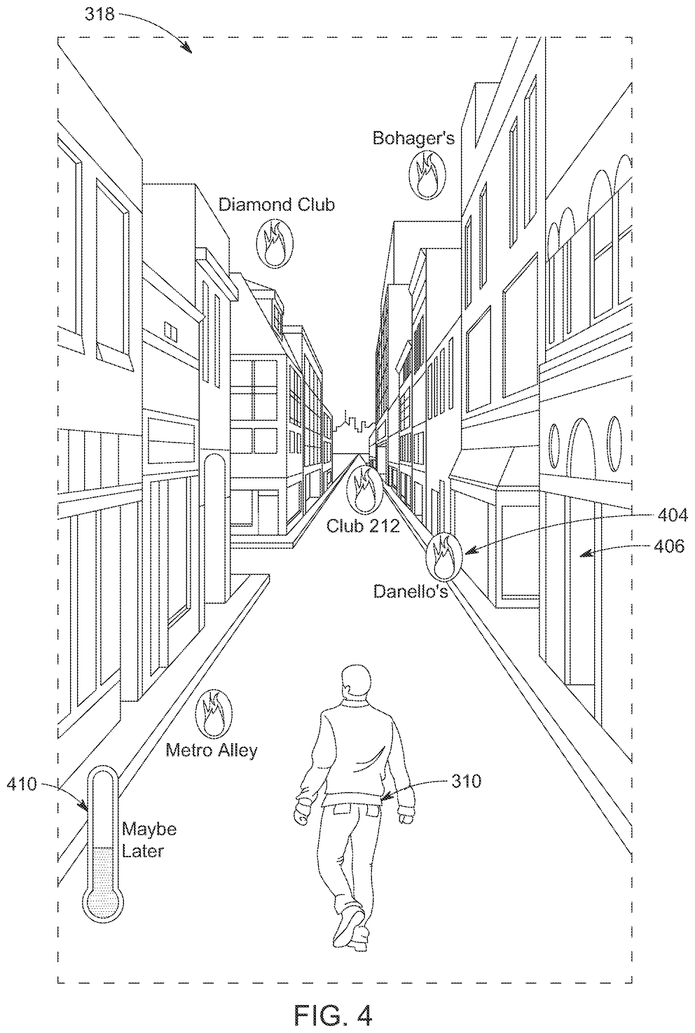

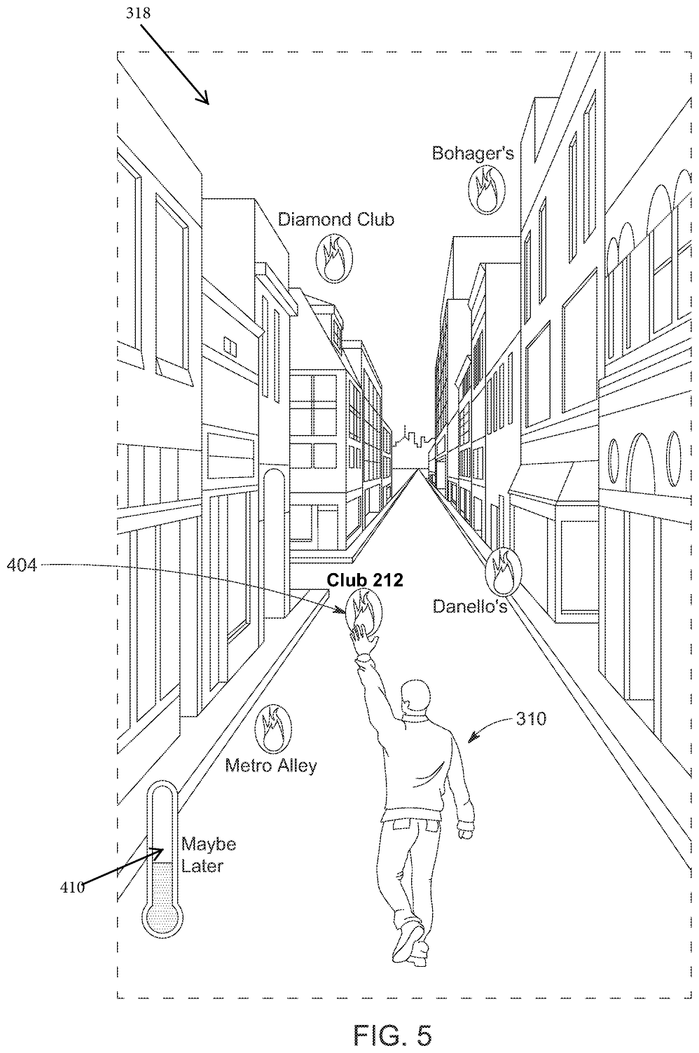

In a non-limiting embodiment, an interactive avatar 310 may be selected by a user 132 to represent the user 132 in the experience application 128. FIGS. 4-5 show a non-limiting example of such an avatar 310. The experience application 128 may include multiple template examples of avatars 310 that the user 132 can select including based on resemblance to a physical appearance of the user 132. The user 132 can dress and style the avatar 310 to represent any style the user 132 so desires. In a non-limiting embodiment, the avatar 310 may be selectable using a city mode module 208 incorporated into the experience computer application 128. In a non-limiting embodiment, there may be a virtual area map 314 displayed one or more interfaces and/or one or more modules of the experience application 128. The area map 314 may provide virtual digital displays and/or worlds (e.g., virtual worlds or virtual reality depictions 318 as shown in FIGS. 4-5) with digital renderings of the venues 212 as they generally appear in a real world setting. The area map 314 provides a virtual reality depiction 318 of one or more venues 212 as shown in the examples in FIG. 4-5. The avatar 310 can be shown walking, running, flying, or performing any other action in the virtual reality depiction 318 and interacting with a series of venue virtual icons, including exemplary graphical icons 404 shown in FIGS. 4-5 in order to leave a real-time based review and/or rating.

As shown in FIG. 3, review mode 202 is another module integrated into the experience application 128 dedicated to verifying a location of a user 132 prior to allowing a user 132 to leave his or her review/rating of a venue 212. This is because, as noted above, there are too many examples of fraudulent positive and/or negative reviews and ratings left by people who want to skew the impression that the public has of a particular venue 212, because the people are motivated by various reasons. Oftentimes, people have not even attended a venue 212 but use existing applications and websites, such as YELP or other applications or websites, in order to leave fraudulent reviews.

Notably, the review mode 202 requires a user location verification 326 process to ensure and verify that a user 132 is located at an established geographical location associated with a venue 212. The user 132 may be required to be specifically at or within an acceptable geographical range associated with the venue 212 prior to leaving a review or rating with the review/rating interface 322 or another interface related to the review mode 202 for the experience application 128 to publish a user's review or rating to the public users and other viewers of the experience application 128.

Various technologies may be utilized to verify a user's geographic location 326 including geofencing 328, QR codes 330, Bluetooth beacons 336, and/or RFID tags 332. As noted above, the location aware computing device 100 may include a global positioning system 334. In a non-limiting embodiment, the location aware computing device 100 is a smartphone, tablet, or smartwatch, or another portable computing device.

In a non-limiting embodiment, geofencing 328 may refer to a virtual perimeter or boundary or fence for a real-world geographic area that includes a venue 212. Geofencing 328 relates to the user of a geofence. A geofence could be dynamically generated or match a predefined set of boundaries. When a location aware smart computing device 100 enters or exits a geofence by virtue of the user 132 entering the boundary created around the venue 212's geographical area, the software of the experience application 128 registers this entrance and exit and is a means to verify a user's location at a certain period of time. In a non-limiting embodiment, the experience application 128 may use a geographical information system (GIS) that is provided from a third party application and/or integrated into the experience application 128. Such a GIS module may monitor the created geofence around a venue 212 to determine which specific computing devices 100 have crossed the geofence and take appropriate action. Such action, in one or more non-limiting embodiments, may include wherein the geographical location of the user is obtained using geofencing as determined by the one or more processors of the location aware smart computing device 100. The virtual boundary or fence is monitored by the experience computer implemented application 128 and/or the integrated third party application (e.g., GIS) to determine whether the location aware smart computing device 100 crossed the virtual boundary or the fence. If it is determined that the location-aware smart computing device 100 crossed the virtual boundary or the fence, the experience application 128 affirmatively establishes a presence of the location aware smart computing device 100 as being within the acceptable geographical range of the established geographic location of the particular venue 212. Accordingly, geofencing 328 may be used to verify a user's location 326 as part of the review mode 202.

In another non-limiting embodiment, QR codes 330 may be barcodes located at specific locations at a venue 212 and used to verify a user's location at the venue 212. Accordingly, a user 132 may use the user computing device 100 to scan (using a camera and/or other application on the computing device 100) a QR code 330 at the venue 212. The data associated with the QR code 330 may be provided to the experience application 128 for further verification. Once the experience application 128 receives the data associated with the QR code 330, the experience application 128 can verify the user 132's location and compare to an established geographical location of the venue 212. Notably, the time limited QR codes 330 at the venue 212 can be changed regularly to ensure that only users 132 who attend the venue 212 at a particular date/time can use a particular QR code 330. Accordingly, the QR codes 330 provide a reliable, secure way to verify a user 132's location matches the location of a venue 212 prior to leaving a review or rating.

Another location estimation technology that may be used is one or more Bluetooth beacons 336 that may be located at a venue 212. Bluetooth beacons 336 may be small wireless devices that use BLUETOOTH connectivity to transmit a constant radio signal. The constant radio signal is broadcast and can be intercepted by one or more modules of the experience application 128 on a user's computing device 100 along with an ID number associated with the Bluetooth beacon 336. The broadcasted signal and ID number, in one or more non-limiting embodiments, may be transmitted to a monitoring server 138 on a hosting system 136 that is associated with the administrative entity 134. The monitoring server 138 verifies whether the ID number is assigned to the one or more Bluetooth beacons 336 positioned at the established geographical location of the venue 212 and/or within an acceptable geographical range for the particular venue 212. In this manner, Bluetooth beacons 336 may be used to verify a user 132's location at a venue 212 and determine whether they are the same or not prior to allowing a user 132 to leave a dated review/rating of a venue 212.

Another example of a location estimation technology that may be utilized for user location verification 326 may be the use of RFID tags 332. One or more RFID tags 332 may be and/or attached to the location aware computing device and used to determine the geographical location of the user in relation to the venue 212 in one or more non-limiting embodiments.

It is noted that the geofencing 328 may utilize GPS 332 and/or RFID technology 332 to create a virtual geographic boundary, enabling software of the experience application 128 to trigger a response when a mobile device 100 enters or leaves a particular area, such as the established geographic location of the venue 212.

Indeed, any use of the geofencing 328, QR codes 330, Bluetooth beacons 336, or RFID tags 332 may be utilized to trigger a response when the mobile device 100 enters or leaves the acceptable geographical range for the established geographic location of the venue 212.

In a non-limiting embodiment, the experience application 128 further includes a resolution interface 324 or fix it interface that allows management or other authorized parties associated with a venue 212 to review any reviews/ratings that a user 132 has provided, but only after the user 132's location is verified as being located at a venue 212. The resolution interface 324 may be a module that notifies the venue 212 of the existence of a review and/or rating provided by a user 132 and also that the user 132's location was verified as being at the venue 212. The management or authorized representative party of the venue 212 may be allowed to reply to the user 132 prior to allowing the user 132 to post the review or rating via the review mode 202 of the experience application 128. This may give the management or other authorized party of the venue 212 the ability to respond to the user 132 if the user has a negative experience in particular as indicated by the review or rating shared with the venue 212 prior to publication to all the users on the experience application 128. The management of the venue 212 may also be given a chance to dialogue with the user 132 even if the user is wanting to leave a positive review or rating. The management may provide the user 132 with incentives, perks, refunds, or other items as a response to the shared rating/review that is about to be published on the experience application 128. Thus, the management or other authorized party of the venue 212 is given the opportunity to respond in real time to a user 132 who may still be located at the venue 212 at the time the review/rating is shared with the venue 212.

Any reviews/ratings left on the review mode 202 may be kept for a limited period of time. In a non-limiting embodiment, the limited period of time may range from one week to one month to one year. This may allow for the reviews/ratings to be as current as possible and not to allow older positive or negative reviews/ratings influence other customers perception of a venue 212 and influence their decision to go to a venue 212 or not.

As shown in FIG. 3, a digital rending and version of the virtual ranking/ratings 316 of a venue 212 may be displayed on the digital, virtual display of an area map 314 in one or more non-limiting embodiments, including the vetted, real time reviews/ratings shown on the experience application 128.

As shown in FIG. 3, the experience application 128 may further provide a venue growth analysis 340, which provides charts and other visual displays to the venue 212 showing the ratings/reviews provided as feedback by the customers of the venues 212 and shared on the experience application 128. The venue growth analysis 340 portion of the experience application 128 may allow businesses to see the change over time of the reviews/ratings and target their performance to improve or maintain certain factors based on the review/ratings provided from actual customers of the venues 212 that were vetted in real time.

FIGS. 4-5 show example virtual worlds 318 that may be displayed on the display device of a user 132 in the city mode 208 of the experience application 128 in which the user 132 has their own personal avatar 310. As shown in FIGS. 4-5, the virtual world 318 reflects the real surroundings of the user 132 at a particular geographic area and may further include names of venues 212 which have virtual graphical representations 406 in that area as well as graphical icons 404. The graphical icons 404 may be interactive such that the user's avatar 310 can select the graphical icons 404 to leave a review or rating. For example, the graphical icons 404 may digital, graphical depictions of intense flames (e.g., as shown in FIGS. 4-5), glowing flames, coals, and skulls depending on the reviews and/or ratings provided from the users 132 via the review mode 202. As shown in FIG. 4 and in FIG. 5, there may also be a graphically interactive thermometer 410 the user 132 can interact with and select to indicate whether the user 132 wants to visit a particular venue 212 or not. As shown in FIG. 4, the interactive avatar 310 is able to interact with the levitating graphical icons 404 for any of the virtual venues 406.

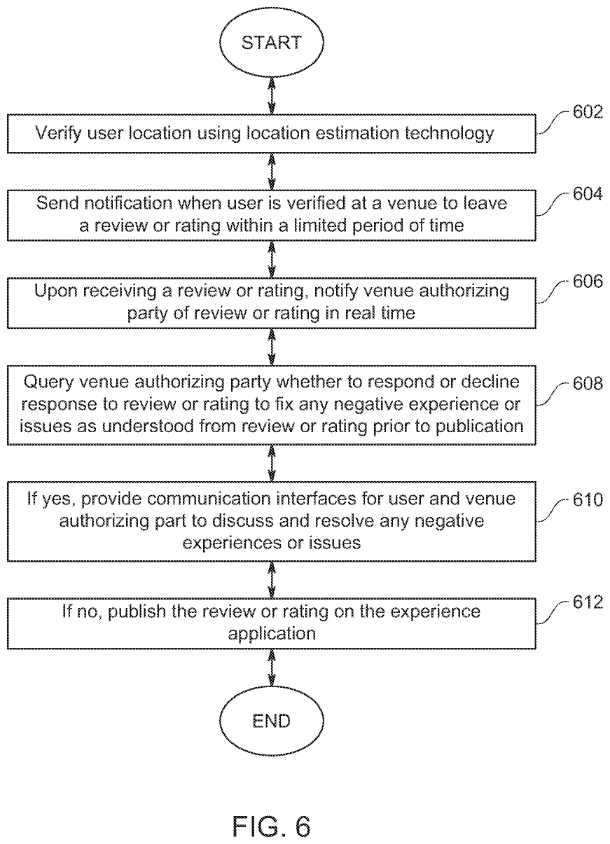

FIG. 6 depicts a flowchart for a method of using an experience application 128. In a non-limiting embodiment, the method may include verifying a user's location using location estimation technology as shown at step 602. Some exemplary location estimation technologies have been described above with respect to FIG. 3. For example, the location aware smart computing device 100 may incorporate GPS 334 and one or more geofencing techniques 328 may be used to verify a user's location with respect to a particular venue 212. Additionally, the location aware smart computing device 100 may incorporate Bluetooth connectivity and include one or more Bluetooth beacons 336. The venue 212 may further incorporate QR codes 330 that can be scanned using one or more cameras or other devices integrated into the location aware smart computing device 100 in order to verify a user's location. In another non-limiting embodiment, one or more RFID tags 332 can be associated with the user computing device 100 and and/or removably attached to either a case holder for the smart computing device 100 or the device 100 itself. These are examples of technologies that may be used to estimate and perform user location verification 326 before allowing a user 132 to leave a real time based rating or review of a particular venue 212.

At step 604, the computer implemented method may include sending a notification to the user 132 via one or more processors of the location aware computing device 100 and via the experience application 128 that the location of the user 132 has been verified and associated with a particular acceptable range within an established geographical location of the venue 212 and that the user 132 may leave a review or rating of the venue 212. In a non-limiting embodiment, the user 132 has a limited period of time to leave the review or rating of the venue 212 after the user 132's geographical location has been verified. If the user 132 does not leave review or rating of the venue 212 within the designated period of time, the time period expires within which the user 132 may provide a review and/or rating of the venue 212. In a non-limiting embodiment, if the time period expires, then the geographical location of the user 132 has to be verified again prior to the user 132 being able to leave a real time based review and/or rating of the venue 212.

At step 606, upon receiving a review or rating, the computer implemented method may include notifying an authorizing party or administrative authority of the venue 212 of the review or rating that the user 132 has just provided in real time. Further, the authorizing party and/or administrative party of the venue 212 may be given the opportunity to view the review/rating that is about to be left by the user 132.

At step 608, the method may include querying the authorizing party or administrative authority of the venue 212 whether the authorizing party of administrative entity of the venue 212 chooses to respond or to decline (e.g., as shown in FIG. 3) in response to a user's review and/or rating in order for the venue 212 representatives to have a chance to fix and/or address any negative experiences as understood from the review/rating shared with the administrative entity/authorizing party of the venue 212 prior to publication of the review or rating on the computer implemented experience application 128. As shown at step 610, if the management or authorizing party of the venue 212 choose to respond, then the experience application 128 may provide a communication interface (e.g., resolution interface 324) for the user 132 and representative of the venue 212 to discuss and resolve any negative (or other type) of experience the user 132 may have had at the venue 212 as indicated by the user's review or rating. Accordingly, in this manner, in a non-limiting embodiment, the experience application 128 may integrate a module, such as the resolution interface 324 with the review mode 202 module of the experience application 128 and offer the venue 212 an opportunity to interact with the user 132 to resolve any issues, in particular if the user 132 has a negative impression of the venue 212, prior to the review/rating being published and being shared with other users 132 of the experience application 128. A noted advantage of such a resolution interface 324 as part of the review mode module 202 of the experience application 128 is that the venue 212 can monitor the service provided to the user's 132 in real time because the user 132 is only allowed to provide the review and/or rating if the user 132 is physically at a particular venue 212 or within a very limited geographical range. Therefore, the management or administrative party of the venue 212 may choose to provide the user 132 with compensation or other desirable perks while a user 132 is still at the venue 212 to resolve any negative experiences/issues as indicated by the review or rating shared with the management or authorizing party of the venue 212 prior to publication. In other embodiments, the management or authorizing party of the venue 212 may further respond to the user 132 and/or offer rewards, benefits if the review/rating is positive, and therefore the resolution interface module 324 is not limited in its use to negative experiences, issues, or comments left by the user 132 only.

If the management declines to respond to the user review/rating, as shown at step 612, then the user 132 review/rating may be published and shared publicly with the other users and viewers on the experience application 128. As noted above, in an effort to keep very current and recent reviews that are accurate and not outdated, the experience application 128 may be configured to delete and remove any reviews and/or ratings that have exceed a period of time being displayed on the experience application 128. In this manner, users 132 are provided with timely, current, and the most relevant set of reviews/ratings to reflect the current reality of service, entertainment, or experiences to be had at a venue 212.

In a non-limiting embodiment, the experience application 128 may offer rewards to the user 132 who provides high value information, performs a desired activity. The reward may be in the form of a token that has value and may be redeemed in some manner. In a non-limiting embodiment, the token or other form of reward may be used towards in-app reward purchases. In other embodiments, the user 132 may be able to obtain products, services, attend events, or receive any other type of gift or reward based on the user 132's providing a review (e.g., via review mode 202) or performing some other desired activity. The experience application 128 thus may acquire user 132 interest and participation by offering tokens or other reward programs that can facilitate receiving reviews and other desired responses from the user 132.

Any information entered by the user may be returned into the administrative system for the experience application 128 so as to improve the data processing of the experience application 128. For example, the experience application 128 may suggest locations of interest to the user 132 based on the reviews submitted and feedback about positive versus negative experiences. Further, data from the experience application 128 can be shared with authorized vendors/venues 212 so that they may learn how to improve the products or services offered based on the feedback of actual, vetted users 132. The experience application 128 may utilize artificial intelligence/machine learning to self-correct and improve the interfaces and key features provided to the user 132. As noted above, one or more trained machine learning models integrated in the experience application 128 may be used to suggest a relevant set of venues 212 based in part on the user's profile 302, user preferences 304, preferred venue ranking 306, and/or preferred venue rating 308. The one or more trained machine learning models may further sort and organize potential venue recommendations 312 based on geographic proximity in association with consideration for the user's profile 302, user preferences 304, preferred venue ranking 306, and/or preferred venue rating 308.

As described above, experience application 128 offers a variety of features and functions, including the review mode 202, hot zone mode 204, car mode 206, city mode 208, and chauffeur mode 210. It is beneficial that the reviews viewable in review mode 202 are verified in order to determine and ensure that the reviewer actually visited a venue 212 at any given date and for a particular period of time. Further, in a non-limiting embodiment, the reviews are only left up or visible for a short period of time (e.g., a week or less) and thereby the experience application 128 is constantly obtaining and sharing only very accurate reviews that are recently provided. Typically, current review sites or social media will leave up reviews indefinitely about any particular venue 212 and therefore, the user 132 may be forced to rely on a review on a website that is really very old. The experience application 128 provides a better computer implemented system and method for obtaining accurate and verified reviews as well as provides all the various interactive features of hot zone 204, which allows users 132 to select other destinations of interest to attend or to store in the experience application 128 for attending at a later time. Further, the car mode 206 provides a fun and interactive experience with the virtual dashboard of the experience application 128 and the city mode 208, as shown for example in FIGS. 4-5, provides an interactive virtual avatar 302 that the user 132 can interact with in a virtual reflection of the user 132's real life surroundings. Many other advantages and benefits are offered by the experience application 128 in one or more non-limiting embodiments.

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with; and/or in the context of other particular aspects and embodiments of the invention; and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

The term “set” as used herein may refer to one or more. Accordingly, a set may include one item or several items.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A computer implemented application for providing accurate real time reviews or ratings of venues and locator of venues, comprising:
obtaining, via one or more processors of a location aware smart computing device, a geographical location of a user at a particular venue prior to allowing a user to submit a review or a rating of the particular venue;
comparing, via the one or more processors, the geographical location of the user with an established geographical location of the particular venue;
determining, via the one or more processors, whether the geographical location of the user is within an acceptable geographical range from the established geographical location of the particular venue; and
if the geographical location of the user is determined, via the one or more processors, to be within the acceptable geographical range from the established geographical location for the particular location, prompting the user to provide the real time review and/or the real time rating on the computer implemented application,
wherein fraudulent reviews or ratings of the particular venue are prevented by verifying the geographical location of the user.

2. The computer implemented method of claim 1, wherein a user is provided with a limited period of time to provide the real time review and/or the real time rating otherwise a time limit expires and a verification process of the geographical location of the user occurs again.

3. The computer implemented method of claim 1, wherein the location aware smart computing device comprises a global positioning system (GPS).

4. The computer implemented method of claim 1, wherein the geographical location of the user is obtained using geofencing as determined by the one or more processors of the location aware smart computing device.

5. The computer implemented method of claim 4, where the geofencing comprises creating a virtual boundary or fence in the computer application and/or an integrated third party application dedicated to operate as a geographical information system (GIS) around the established geographical location of the particular venue.

6. The computer implemented method of claim 5, wherein the virtual boundary or fence is monitored by the computer implemented application and/or the integrated third party application to determine whether the location aware smart computing device crossed the virtual boundary or the fence.

7. The computer implemented method of claim 6, wherein if it is determined that the location-aware smart computing device crossed the virtual boundary or the fence, the computer implemented application affirmatively establishes a presence of the location aware smart computing device within the acceptable geographical range of the established geographic location of the particular venue.

8. The computer implemented method of claim 1, wherein the geographical location of the user is obtained by receiving QR code data specific to the particular venue from QR codes, wherein the QR codes are only scannable if the user is at the particular venue and are available only during certain time periods.

9. The computer implemented method of claim 1, wherein the geographical location of the user is obtained by using one or more Bluetooth beacons positioned at the particular location.

10. The computer implemented method of claim 9, wherein the one or more Bluetooth Beacons transmits a signal to the location aware smart computing device and an ID number that is transmitted to a monitoring server, wherein the monitoring server verifies whether the ID number is assigned to the one or more Bluetooth beacons positioned at the established geographical location of the venue.

11. The computer implemented method of claim 10, wherein the monitoring server transmits a response to the computing application in response to the determination made by the one or more processors of the location aware smart computing device whether the geographical location of the user is within the acceptable geographical range from the established geographical location and range for the particular venue.

12. The computer implemented method of claim 1, wherein one or more RFID tags are associated and/or attached to the location aware computing device and used to determine the geographical location of the user in relation to the venue.

13. The computer implemented method of claim 1, further comprising, a venue response resolution module integrated in the computer implemented application that notifies a venue of the real time review and/or the real time rating prior to allowing a user to publish the real time review and/or the real time rating, and allows the venue an opportunity to respond to the user via the computer implemented application to fix or improve a user's experience at the venue prior to publication of the user's real time review or the real time rating on the computer implemented application for other users to view.

14. The computer implemented method of claim 1, wherein the computer implemented application further comprises a module for creating an area map, wherein the area map is a virtual rendering of one or more venues in a particular area.

15. The computer implemented method of claim 1, wherein the area map includes virtual icons associated with the one or more venues as displayed on the area map.

16. The computer implemented method of claim 1, wherein any reviews or ratings provided by the user and other users of the computer implemented application are viewable to the user on the computer implemented application from the area map.

17. The computer implemented method of claim 1, wherein the computer implemented application sends notifications to the user of potential venue recommendations based on the user preferences, including a preferred venue ranking and/or preferred venue rating, wherein a machine learning module is integrated into the computer implemented application and includes a series of layers to map variables to determine the potential venue recommendations and suggest a relevant set of the potential venue recommendations.

18. The computer implemented method of claim 1, wherein the computer implemented application comprises a module for a user to associate an interactive virtual avatar with a user profile of the user.

19. The computer implemented method of claim 18, wherein the interactive virtual avatar is configured to interact with graphical icons that indicate a level of crowdedness, activity, and energy associated with the particular venue on a virtual area map displayed on the computer implemented application.

20. The computer implemented method of claim 19, wherein the graphical icons are affected by group ratings and reviews as provided by users of the computer implemented application.
